(19) United States
(12) Patent Application Publication
(10) Pub. No.: US 2002/0028010 A1
(43) Pub. Date: Mar. 7, 2002

(54) Method and apparatus for outputting optical tomographic image diagnostic data

(75) Inventor: Masahiro Toida, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/945,749

(22) Filed: Sep. 5, 2001

(30) Foreign Application Priority Data
Sep. 5, 2000 (JP) 268561/2000
Sep. 26, 2000 (JP) 292021/2000
Jul. 30, 2001 (JP) 229050/2001

(51) Int. Cl. G06K 9/68; G06K 9/00

(52) U.S. Cl. 382/131; 382/218

(57) ABSTRACT

A fiber coupler separates, the low-coherence light emitted from a light source into a signal-light to be projected onto a target subject and a reference-light whose wavelength is shifted by a Piezo element, and combines the signal-light reflected from a predetermined depth within the target subject with the reference-light. A balance differential detector detects the signal strength of the interference-light after said combining, and said signal is processed by the signal processor; whereby an optical tomographic image of the target subject is obtained, and output to a monitor and to the diagnostic data output portion. The diagnostic data output portion performs pattern-matching between the optical tomographic image of the target subject and the pattern of a prerecorded standard optical tomographic image obtained of a normal tissue. If the two patterns substantially match, that the target subject is in the normal state is output to the monitor and displayed.

### BACKGROUND OF THE INVENTION

1. Field of the Invention

The present invention relates generally to a method and apparatus for outputting optical tomographic image diagnostic data, and more particularly to providing the diagnostic data relating to an area of examination of a subject tissue based on an optical tomographic image obtained upon the irradiation thereof by a low-coherence light.

2. Description of the Related Art

In recent years, accompanying the so-called graying of society (i.e., the proportional increase in the number of citizens of retirement age) as well as increased detection rates of cancer and the like, there has been an increase in the frequency with which surgery to remove cancerous and other diseased tissue is performed. Generally, such surgery has the objective of completely halting the disease, and it is often the case that in addition to the diseased tissue, a slight amount of normal tissue surrounding the diseased tissue is also removed. Further, after the diseased tissue has been surgically removed, a test for pathology is performed thereon and a check is performed to determine whether or not all of the diseased tissue has been removed, and the post-surgical treatment is decided. In the surgery stage, there are many cases in which it is difficult to discern the boundary between the diseased tissue and the normal tissue with the naked eye. In such cases, in order to ensure that the diseased tissue is completely removed, a wide swath of tissue bordering thereon is often removed as well, and the burden on the patient is great.

In recent years, both the complete halting of the disease and the preservation of the QOL (Quality of Life) of the patient are sought; therefore, it has become an increasingly common practice to perform an on-the-spot test for pathology to prevent the unnecessary removal of normal tissue: during the course of the surgery, a test for pathology is performed on a portion of removed tissue, and by confirming the boundary between the diseased tissue and the normal tissue, as well as the type of disease, the amount of range of the normal tissue required to be removed from the vicinity surrounding the diseased tissue can be kept to a minimum.

However, when the pathology of a section of diseased tissue that has been removed is to be determined during the course of performing surgery, a sample of the diseased tissue that has been removed is taken and a specimen is prepared and examined under a microscope and diagnosed by a pathologist, for which a minimum of at least 30 minutes is required. Therefore, for cases in which a section of diseased tissue is surgically removed and a determination is to be made by performing a test for pathology on a portion of the removed tissue as to whether or not it is necessary to remove an even larger section of tissue, the surgery must be interrupted for a period of at least 30 minutes. Therefore there is a strong demand for a method to be developed that provides for the expedient and accurate pathological diagnosis.

On the other hand, the development of OCT (Optical Coherence Tomography), in which a low-coherence light is utilized, has been advancing: apparatuses such as a heterodyne detection OCT apparatus for obtaining an optical tomographic image of the examination area of a subject tissue (hereinafter referred to as a target subject) by measuring the signal strength of the light-beat produced due to the interference of the slightly shifted low-coherence light; a light-separation OCT apparatus which, for obtaining an optical tomographic image of a target subject by measuring the interference signal due to the interference of the low-coherence light, and etc. These apparatuses are being used to obtain optical tomographic images of the microscopic structures of a target subject, etc.

A detailed description of the aforementioned heterodyne detection OCT apparatus can be found in an article in “O Plus E” Vol. 21, No. 7, pp. 802-04, 1999, by Masamitsu Haruna. According to the aforementioned OCT apparatus: the low-coherence light emitted from a light source formed of an SLD (Super Luminescent Diode) or the like, is separated into a signal-light and a reference-light; the wavelength of the signal-light or the reference-light is slightly shifted by use of a Piezo element or the like; the target subject is irradiated with the signal-light and interference is caused between the reflected-light reflected from said target subject at a predetermined depth and the reference-light; the signal strength of the light-beat produced due to said interference is measured by a heterodyne wave detection; and the tomographic data based on the reflectance ratio of the signal-light is obtained; wherein, by very slightly moving a movable mirror, etc. disposed above the optical path of the reference-light, causing the length of the optical path of the reference-light to change slightly, the length of the optical path of the reference-light and the length of the optical path of the signal-light can be made to be equal, and the reflectance ratio for a predetermined depth of the target subject can be obtained.

Further, a detailed description of the aforementioned light-separating OCT apparatus can be found in an article in “Optics Letters”, Vol. 25, No. 2, pp. 111-13, 2000, by U. Morgner, et al. This OCT apparatus operates as follows: the low-coherence light emitted from the light source formed of an Ti-sapphire laser or the like is separated into a signal-light and a reference-light; the target subject is irradiated with the signal-light and interference is caused between the reflected-light reflected from said target subject at a predetermined depth and the reference-light; the signal strength of the interference signal thereof is measured ad subjected to a Fourier transform signal processing or the like; and based on the reflectance ratio of the signal-light contained in the interference signal and/or the light-separation data of the target subject, an optical tomographic image is obtained; wherein, by very slightly moving a movable mirror, etc. disposed above the optical path of the reference-light, thereby causing the length of the optical path of the reference-light to change slightly, the length of the optical path of the reference-light and the length of the optical path of the signal-light can be made to be equal, and the separated light data for a predetermined depth of the target subject can be obtained.

According to such OCT apparatuses, in order to obtain the data of tomographic data occurring at a desired depth of a target subject, although it is ideal that the interference in the signal-light and the reference-light occur only when the length of the signal-light optical path and the length of the reference-light optical path are completely matched, in actual practice, if the length of the difference between the length of the signal-light optical path and the length of the reference-light optical path is equal to or less than the coherence length of the light source, interference is produced.

That is to say, the resolution of the interference occurring in low-coherence light is determined by the coherence length of the light emitted by the light source.

In recent years the field of clinical medicine has seen wider recognition afforded to the usefulness of optical tomographic images of target subjects, etc., and it has become desirable that optical tomographic images having a high resolution can be obtained of target subjects having a high degree of light dispersion. To attain such a result, a high-output light source that is also capable of emitting low-coherence light having a short coherence length is required. For example, an apparatus described in an article in “Optics Letters”, Vol. 21, No. 22, pp. 1839-41, 1996, by B. E Bouma et al, is provided with a KLM mode-locked Ti-sapphire Laser utilizing a micro-pulse light and optical fiber dispersion delay to attain a high-output of low-coherence light having a short coherence length, which, when used for emitting signal-light and reference-light, is capable of obtaining optical tomographic images having a high resolution. Further, the inventors of the present invention have proposed as light sources for emitting low-coherence light having a short coherence length, those in which the laser-light spectrum is widened by use of an amplification fiber that has been integrated into a optical fiber light source, or by use of fiber-grading, etc.

By using a light source such as those described above for emitting low-coherence light having a short coherence length, an optical tomographic image having a high resolution, that is, a cellular-level optical tomographic image can be displayed. Therefore, based on such optical tomographic images, pathological diagnosis becomes possible, to diagnose whether the tissue of a target subject is in a normal state or a diseased state, e.g. cancerous, etc.

That is to say, by obtaining of a target subject a high-resolution optical tomographic image such as that described above, the diagnosis of the cause of the disease can be performed expediently without preparing a specimen of the diseased tissue. Therefore, the amount of time required for diagnosing the cause of the disease as well as the time required for the surgery can be reduced.

However, because there is an extremely small number of doctors capable of accurately diagnosing pathology from a cellular-level optical tomographic image, a problem has arisen in that it has been difficult for many medical facilities to actually put the on-the-spot optical tomographic image diagnostic method, which is a low burden method for both the patient and the examiner, into practice.

### SUMMARY OF THE INVENTION

The present invention has been developed in consideration of the circumstances described above, and it is a primary object of the present invention to provide a method and apparatus for outputting optical sectional diagnostic data capable of carrying out, by use of an optical tomographic image, expedient diagnosis of the tissue state of a target subject even for cases in which it is difficult or impossible for a pathologist to perform said diagnosis.

The first method of outputting optical tomographic image diagnostic data according to the present invention comprises the steps of: obtaining an optical tomographic image of a target subject using the interference of a low-coherence light having a coherence length of 5 um or less; comparing the pattern of the optical tomographic image obtained of the target subject to the pattern of an optical tomographic image obtained of a tissue known to be in the normal state and/or the pattern of an optical tomographic image obtained of a tissue known to be in a diseased state; and outputting, based on said comparison, the data relating to the tissue state of the target subject.

The second method of outputting optical tomographic image diagnostic data according to the present invention comprises the steps of: obtaining an optical tomographic image of a target subject using the interference of a low-coherence light having a coherence length of 5 um or less; comparing the pattern of the optical tomographic image obtained of the target subject to a plurality of patterns of the optical tomographic images, including a pattern obtained of a tissue known to be in the normal state and a pattern obtained of at least one tissue known to be in a type of diseased state, and based on a determination as to which pattern from among said plurality of patterns of optical tomographic images known to be in a certain state most matches the pattern of the optical tomographic image of the target subject, outputting the data relating to the tissue state of the target subject.

The third method of outputting optical tomographic image diagnostic data according to the present invention comprises the steps of: transmitting an optical tomographic image obtained of a target subject to a remote location via a communications network; wherein, the location receiving said transmitted optical tomographic image obtains and outputs the diagnostic data relating to the tissue state of the target subject of the transmitted optical tomographic image, and said output diagnostic data is received via the communications network at the location at which said transmitted optical tomographic image was obtained.

The fourth method of outputting optical tomographic image diagnostic data according to the present invention comprises the steps of: recording an optical tomographic image obtained of tissue known to be in a normal state; comparing the pattern of an optical tomographic image obtained of a target subject to the pattern of aforementioned optical tomographic image obtained of tissue known to be in a normal state and determining whether or not both patterns substantially match; and transmitting, only if both patterns do not substantially match, said optical tomographic image of the target subject over a communications network to a remote location; wherein, the location receiving said transmitted optical tomographic image obtains and outputs the diagnostic data relating to the tissue state of the target subject of the transmitted optical tomographic image, and said output diagnostic data is received via the communications network at the location at which said transmitted optical tomographic image was obtained.

The first apparatus for outputting optical tomographic image diagnostic data according to the present invention comprises: an OCT means for obtaining an optical tomographic image of a target subject by using the interference of a low-coherence light having a coherence length of 5 um or less; a recording means for prerecording an optical tomographic image obtained of a tissue known to be in the normal state and/or an optical tomographic image obtained of a tissue known to be in a diseased state; and a diagnostic data output means for outputting, based on a comparison of the pattern of the optical tomographic image obtained of the target subject by the OCT means to the pattern of an optical tomographic image obtained of a tissue known to be in the normal state and/or the pattern of an optical sectional tissue obtained of a tissue known to be in a diseased state, the data relating to the tissue state of the target subject.

Here, the method of “outputting, based on a comparison of the pattern of the optical tomographic image obtained of a target subject by the OCT means to the pattern obtained of a target subject known to be in the normal state and/or the pattern of an optical tomographic image obtained of a tissue known to be in a diseased state, the data relating to the tissue state of the target subject” occurring in the first embodiment of the method and apparatus for outputting optical tomographic image diagnostic data can be of any method wherein, based on the performance of aforementioned comparison of patterns, the diagnostic data relating to the target subject is output: for example, said comparison of patterns is performed, and if the pattern of the optical tomographic image of the target subject substantially matches either the pattern of the optical tomographic image obtained of a tissue known to be in the normal state, or the optical sectional pattern of a tissue known to be in a diseased state, the tissue state of the target subject is recognized to match the tissue state represented by the pattern determined to substantially match therewith, and the name of the tissue state, or the degree to which the patterns match is output as the diagnostic data.

The second apparatus for outputting optical tomographic image diagnostic data according to the present invention comprises: an OCT means for obtaining an optical tomographic image of a target subject by using the interference of a low-coherence light having a coherence length of 5 um or less; a recording means for prerecording a plurality of optical tomographic images, including an optical tomographic image obtained of a tissue known to be in the normal state and at least one optical tomographic image obtained of a tissue known to be in a type of diseased state; and a diagnostic data output means for obtaining and outputting, based on the a comparison of the pattern of the optical tomographic image obtained of the target subject by the OCT means to the pattern of each of said plurality of optical tomographic images, each of which has been obtained of a tissue known to be in a certain state, including the pattern of an optical tomographic image obtained of a tissue known to be in a normal state and the pattern of at least one optical tomographic image of a tissue known to be in a type of diseased state, to determine which of said patterns from among the optical tomographic images obtained of a tissue known to be in a certain state most closely matches the pattern of said optical tomographic image of the target subject, the diagnostic data relating to the tissue state of the target subject.

Here, the method of “outputting, based on the a comparison of the pattern of the optical tomographic image obtained of the target subject by the OCT means to the pattern of each of said plurality of optical tomographic images, each of which has been obtained of a tissue known to be in a certain state, including the pattern of an optical tomographic image obtained of a tissue known to be in a normal state and the pattern of at least one optical tomographic image of a tissue known to be in a type of diseased state, to determine which of said patterns from among the optical tomographic images obtained of a tissue known to be in a certain state most closely matches the pattern of said optical tomographic image of the target subject, the diagnostic data relating to the tissue state of the target subject” refers to performing pattern matching between the pattern of the optical tomographic image obtained of the target subject and the pattern of each optical tomographic image obtained of a tissue known to be in a certain state to determine which pattern thereof most closely matches that of the pattern of said optical tomographic image obtained of the target subject, and outputting the name of the tissue-state of the tissue of the image whose pattern has been determined to have the highest degree of matching to the pattern of said optical tomographic image of the target subject, together with the degree of matching, etc.

According to the third apparatus for outputting optical tomographic image diagnostic data according to the present invention: aforementioned OCT means and aforementioned diagnostic data output means are each provided at a location remote to the other; further comprising a transmitting means for transmitting an optical tomographic image obtained of a target subject by said OCT means to said diagnostic data output means via a communications network; wherein aforementioned OCT means is provided with a receiving means for receiving via the communications network the data relating to the diagnosis of the tissue state that has been obtained by said diagnostic data output means, based on the transmitted optical tomographic image, and then output.

That is to say, according to the third method and apparatus for outputting optical tomographic image diagnostic data: an optical tomographic image obtained of a target subject is transmitted over a communications network to a computation room, etc. which has been provided with a diagnostic data output means for obtaining and outputting data relating to the diagnosis of the tissue state of a target subject, wherein the data relating to the tissue state of a target subject output from said computation room, etc. is received via a communications network at the location at which said transmitted optical tomographic image was obtained. The computation room, etc. in which the diagnostic data output means is provided is at a location connected by a communications network to the location at which the optical tomographic image was obtained, and even if the locations are separated by a substantial distance, no impediment to the operability of the system is incurred.

According to the fourth apparatus for outputting optical tomographic image diagnostic data according to the present invention: aforementioned OCT means and aforementioned diagnostic data output means are each provided at a locations remote to the other; further comprising a normal-state pattern recording means for prerecording an optical tomographic image obtained of a tissue known to be in the normal state; a determining and transmitting portion for comparing the pattern of the optical tomographic image obtained of the target subject to the pattern of an optical tomographic image obtained of a tissue known to be in the normal state to determine whether or not the two patterns substantially match, and transmitting, only for cases in which the two patterns do not substantially match, said optical tomographic image obtained by the OCT means of the target subject to the diagnostic data output means; wherein aforementioned OCT means is provided with a receiving means for receiving via the communications network the data relating to the diagnosis of the tissue state that has been obtained by said diagnostic data output means, based on the transmitted optical tomographic image, and then output.

That is to say, according to the fourth apparatus for outputting optical tomographic image diagnostic data according to the present invention: the optical tomographic image of a target subject is transmitted over the communications network to the computation room, in which the diagnostic data output means has been provided, only if the pattern of an optical tomographic image obtained of a target subject does not substantially match the pattern of an optical tomographic image obtained of a tissue known to be in a normal state, that is, only the optical tomographic images of tissue suspected to be in a diseased state is received at the computation room to which it has been transmitted via the communications network. Then, the diagnostic data output by said computation room is received via the communications network.

Note that the referent of the expression “both patterns substantially match” is not limited to only cases in which both images completely match, but also includes cases in which there are many points in the two images that match. Accordingly, the referent of the expression “cases in which both patterns do not substantially match” is not limited to only cases in which it was not possible to arrive at a determination that the patterns completely matched so that target subject could not be determined to be in a normal state, but also includes cases for which a portion of the respective patterns has been found to match, and additional, more accurate analysis by the diagnostic data output means is thought to be required.

As to aforementioned OCT means: a means that separates a low-coherence light having a coherence length of 5 um or less into a signal-light and a reference-light; irradiates a target subject with the signal light; causes interference between the reference-light and the reflected-light of the signal-light reflected from a predetermined depth of the target subject; measures the signal strength of the interference signal after said interference; and obtains an optical tomographic image of the target subject, can be employed. Note that concrete examples, such as a light-separating OCT means, exist.

Further, the OCT means employed can also be an OCT means that separates a low-coherence light having a coherence length of 5 um or less into a signal-light and a reference-light; causes a difference to occur between the frequency of the signal-light and the frequency of the reference-light by shifting the frequency of at least one of the signal-light and the reference-light; irradiates a target subject with the signal light; causes interference between the reference-light and the reflected-light of the signal-light reflected from a predetermined depth of the target subject; measures the signal strength of the light-beat signal after said interference; and obtains an optical tomographic image of the target subject. Note that concrete examples, such as a heterodyne wave detection OCT means, exist.

Note that here, the expression “causes a difference to occur between the frequency of the signal-light and the frequency of the reference-light by shifting the frequency of at least one of the signal-light and the reference-light” refers to, shifting the frequency of at least one of the reference-light and the signal-light, for cases in which the interference between the reference-light and the signal-light is caused after the shifting has been performed, so as to cause a frequency difference producing a strong-weak light-beat that repeats due to the difference between the frequency of the reference-light and the frequency of the signal-light.

As to the aforementioned pattern, a pattern of the form (hereinafter referred to as a form-pattern) or a pattern of the separated light can be employed. Here “a pattern of the separated light” refers to the pattern corresponding to the light-separation data of the target subject displayed in the optical tomographic image: for example, the color characteristics reflected by the light-separation data.

Further, the target subject can be portion of a living body, or a section of tissue that has been surgically removed from a living body. Here “a portion of a living body” refers to a portion of a living body that has not been surgically removed therefrom, that is, a portion of an intact living body. Further, it is preferable that the wavelength of the low-coherence light is in the 600-1700 nm range.

According to the first method and apparatus for outputting optical tomographic image diagnostic data: an optical tomographic image of a target subject is obtained by using the interference of a low-coherence light having a coherence length of 5 um or less; the pattern of the optical tomographic image obtained of the target subject is compared to the pattern of a optical tomographic image obtained of a tissue known to be in the normal state and/or the pattern of an optical tomographic image obtained of a tissue known to be in a diseased state; and because, based on said comparison, the diagnostic data comprised of the name of the tissue state of the pattern with which the pattern of the optical tomographic image of the target subject has been determined to match, the degree of matching, etc., is output, even for cases in which diagnosis of the tissue state of the target subject of the optical tomographic image would be difficult for a pathologist to diagnose, the operator can carry out such a diagnosis, based on the data described above. Therefore, it also becomes possible to perform expedient diagnosis while surgery is being performed.

According to the second method and apparatus for outputting optical tomographic image diagnostic data: an optical tomographic image of a target subject is obtained using the interference caused by a low-coherence light having a coherence length of 5 um or less; the pattern of said optical tomographic image is compared to a plurality of patterns of optical tomographic images obtained of tissues known to be in a certain state, including the pattern of an optical tomographic image obtained of a tissue known to be in the normal state and at least one pattern of an optical tomographic image obtained of a tissue known to be in a type of diseased state; and because, based on a determination as to which of the patterns of the optical tomographic images obtained of each of said tissues that are known to be in a certain state the pattern of the optical tomographic image of the target subject most closely matches, the diagnostic data relating to the tissue state of the target subject is output, even for cases in which diagnosis of the tissue state of the target subject of the optical tomographic image would be difficult or impossible for a pathologist to diagnose, the operator can carry out such a diagnosis, based on the data described above. Therefore, it also becomes possible to perform expedient diagnosis while surgery is being performed.

According to the third method and apparatus for outputting optical tomographic image diagnostic data: an optical tomographic image of a target subject is transmitted to a remote location via a communications network; and because the diagnostic data relating to the tissue state of the target subject of the transmitted optical tomographic image can be obtained at said remote location and output, then transmitted over said communications network and received at the location at which said optical tomographic image of the target subject was obtained, even for cases in which there is no pathologist available to perform diagnosis at the location at which the optical tomographic image of the target subject was obtained, or for cases in which it is not possible to directly perform the operation of obtaining the diagnostic data at the location at which the optical tomographic image of the target subject was obtained, by having the operation to obtain the diagnostic data performed at a remote location and then transmitting the obtained diagnostic data over a communications network, the operator at the location at which the optical tomographic image of the target subject was obtained can receive said diagnostic data and carry out pathological diagnosis based on said diagnostic data. Therefore, it becomes possible to perform expedient diagnosis while surgery is being performed. According to the fourth method and apparatus for outputting optical tomographic image diagnostic data: first, the pattern of an optical tomographic image of a target subject is compared at the location at which said optical tomographic image of the target subject has been obtained, to the pattern of a optical tomographic image obtained of a tissue known to be in the normal state; and only for cases in which the two patterns do not match, the optical tomographic image obtained of the target subject is transmitted via a communications network to a remote location; and by having the operation to obtain the diagnostic data related to the tissue state of the target subject of the transmitted optical tomographic image performed at said remote location, based on said transmitted optical tomographic image obtained of the target subject, and transmitting the diagnostic data obtained thereby over the communications network to the location at which the optical tomographic image of the target subject was obtained; in the same manner as in the third embodiment, even for cases in which there is no pathologist available to perform diagnosis at the location at which the target subject of the optical tomographic image was obtained, or cases in which it is not possible to directly perform the operation of obtaining the diagnostic data at the location at which the optical tomographic image of the target subject was obtained, by having the operation to perform the diagnostic data performed at a remote location and transmitted over a communications network, the operator at the location at which the optical tomographic image of the target subject was obtained can receive said diagnostic data and carry out pathological diagnosis based on said diagnostic data. Therefore, it becomes possible to perform expedient diagnosis while surgery is being performed. Further, for cases in which the pattern of the optical tomographic image substantially matches that of the optical tomographic image obtained of a tissue known to be in the normal state, that is, when a more detailed diagnosis thereof is not necessary or the necessity thereof is low, because the image is not transmitted, the quantity of data transmitted can be reduced, and the amount of time at the receiving location required to obtain the diagnostic data relating to the tissue state of the target subject of a transmitted optical tomographic image can also be reduced.

As to aforementioned OCT means: if a means that separates a low-coherence light having a coherence length of 5 um or less into a signal-light and a reference-light; irradiates a target subject with the signal light; causes interference between the reference-light and the reflected-light of the signal-light reflected from a predetermined depth of the target subject; measures the signal strength of the interference signal after said interference; and obtains an optical tomographic image of the target subject, is employed; the reflectance ratio of the signal-light and/or the light-separation data can be efficiently obtained, and the diagnostic data can be obtained by using the optical tomographic image based thereupon. Further, if the OCT means employed is an OCT means that separates a low-coherence light having a coherence length of 5 um or less into a signal-light and a reference-light; causes a difference to occur between the frequency of the signal-light and the frequency of the reference-light by shifting the frequency of at least one of the signal-light and the reference-light; irradiates a target subject with the signal light; causes interference between the reference-light and the reflected-light of the signal-light reflected from a predetermined depth of the target subject; measures the signal strength of the light-beat signal after said interference; and obtains an optical tomographic image of the target subject; the reflectance ratio of the signal-light can be obtained with a high degree of accuracy, and the diagnostic data can be obtained by using the optical tomographic image based thereon.

Further, if aforementioned pattern is a form-pattern or a pattern of the separated light (hereinafter referred to as a light-separation pattern), pattern matching can be efficiently performed. Still further, if aforementioned pattern is a form-pattern or a light-separation pattern, the diagnostic data can be obtained based on more data variables, and the reliability of the optical tomographic image diagnostic data output apparatus can be improved.

Further, because it is possible to obtain the diagnostic data in a non-invasive manner, without having to surgically remove a tissue from the body of a patient, the burden on the examiner is reduced. Further, the unnecessary removal of healthy tissue can be prevented.

Still further, if the wavelength of the low-coherence light is in the 600-1700 nm range, because the signal light has desirable transmittance and dispersion characteristics with respect to the body of a patient, a desired optical tomographic image data can be obtained.

In addition, if a public communications network is employed as the aforementioned communications network, the diagnostic data relating to the diagnosis of the tissue state of the target subject of an optical tomographic image can be obtained from a desired remote location, and the cost incurred in transmission can be reduced.

### BRIEF DESCRIPTION OF THE DRAWINGS

FIG. 1 is a schematic drawing of an optical tomographic image diagnostic data output apparatus according to the first and second embodiments of the present invention,

FIG. 2 is a schematic drawing of an optical tomographic image diagnostic data output apparatus according to the third embodiment of the present invention,

FIG. 3 is a schematic drawing of an optical tomographic image diagnostic data output apparatus according to the fourth embodiment of the present invention, and

FIG. 4 is a schematic drawing of an optical tomographic image diagnostic data output apparatus according to the fifth embodiment of the present invention.

### DESCRIPTION OF THE PREFERRED EMBODIMENTS

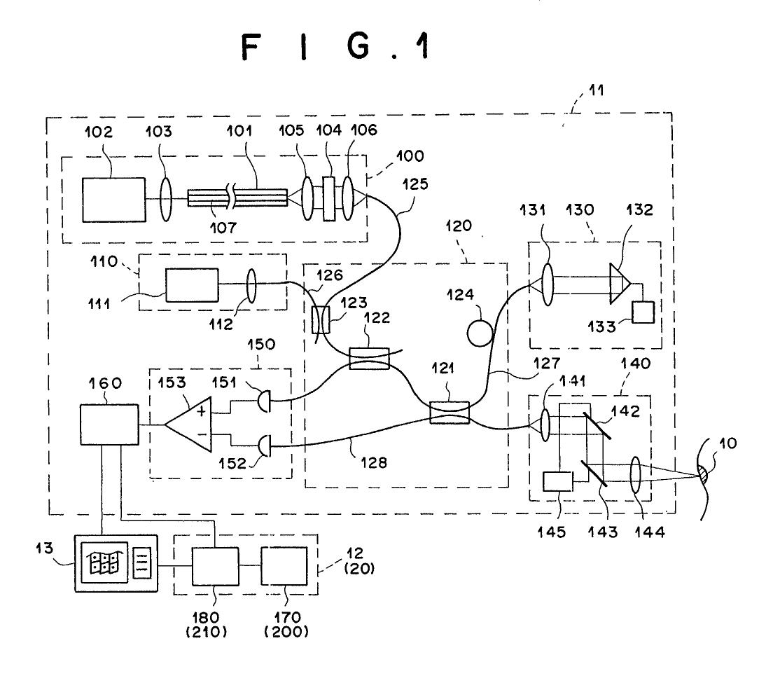

Hereinafter, the preferred embodiments of the present invention will be described with reference to the attached drawings. FIG. 1 is a schematic drawing of an optical tomographic image diagnostic data output apparatus implementing the optical tomographic image diagnostic data output method according to the first embodiment of the present invention. According to said apparatus, pattern-matching is performed between the form-pattern of an optical tomographic image obtained of a target subject 10 and the form-pattern of an optical tomographic image of a tissue known to be in the normal state, and data indicative of whether or not both patterns substantially match is output.

The optical tomographic image diagnostic data output apparatus according to the current embodiment comprises: an OCT portion 11 for obtaining an optical tomographic image of a target subject; a data output portion 12 for performing pattern-matching between the pattern of the optical tomographic image data obtained by said OCT portion 11 and the pattern of an optical tomographic image data obtained of a tissue known to be in the normal state, and outputting data indicative as to whether or not both form-patterns substantially match; and a monitor 13 for displaying as a visible image the optical tomographic image data obtained of the target subject by the OCT portion, as well as displaying the data output by the data output means 12.

The heterodyne type OCT portion 11 comprises: a low-coherence light source 100 for emitting a low-coherence light having a center frequency of 800 nm and a coherence length of 1.4 um; an aiming light source 110 for targeting the target subject 10; a fiber optics coupling system 120 for combining the low-coherence light and the aiming-light, and separating the low-coherence light into a signal-light Ls and a reference-light Lr; an optical path extending portion 130 disposed along the optical path of the reference-light Lr, which causes the length of the optical path of said reference-light Lr to change; a light scanning portion 140 for scanning the target subject 10 with the signal-light Ls; a balance differential detecting portion 150 for detecting the signal strength of the interference signal Lc between the signal-light Ls′ reflected from a predetermined surface of the target subject 10 and the reference-light Lr; and a signal processing portion 160 for performing a heterodyne detection process to obtain the strength of the signal-light Ls′ reflected from a predetermined surface of the target subject 10 from the strength of the interference signal Lc detected by the balance differential detection portion 150, and forming an optical tomographic image data.

The data output portion 12 comprises: a memory portion 170 for prerecording as a standard optical tomographic image data an optical tomographic image data obtained by the OCT portion 11 of a tissue which is known to be in the normal state; and a diagnostic data output portion 180 for performing pattern-matching between the form-pattern of the optical tomographic image data obtained of the target subject 10 by the OCT portion 11 and the form-pattern of the standard optical tomographic image dada prerecorded in the memory portion 170, and determining that the target subject is in the normal state if the form-pattern of the optical tomographic image data obtained of the target subject 10 by the OCT portion 11 and the form-pattern of the standard optical tomographic image data substantially match, and determining that the target subject is suspected to be in a diseased state if the form-pattern of the optical tomographic image data obtained of the target subject 10 by the OCT portion 11 and the form-pattern of the standard optical tomographic image data do not substantially match.

The light source 100 of the OCT portion 11 comprises: an optical fiber light source 101 for emitting low-coherence light upon the entry therein of an excitation light; a semiconductor laser 102 for emitting a laser beam having a wavelength of 600 nm which serves as the excitation light used to excite said optical fiber light source 101; a lens 103 for focusing the excitation light onto the input face of the optical fiber light source 101; an excitation light cutoff filter 104 for cutting the light having a wavelength of 700 nm or shorter, which includes the excitation light, from the low-coherence light; and a lens 105 and a lens 106 for focusing the low-coherence light emitted from the optical fiber light source 101.

The optical fiber light source is an optical fiber having a core 107 at the center thereof, and said core 107 has been doped with colorants that absorb excitation light and emit colors. When the excitation light enters the fiber 101, a low-coherence light having a core wavelength of substantially 800 nm and a coherence length of 1.4 um is emitted from the output face of thereof.

The aiming-light source portion 110 comprises a semiconductor laser for emitting a red laser beam that serves as the aiming-light, and a lens 112 for focusing the aiming-light emitted from said semiconductor laser 111.

The fiber optics coupling system 120 comprises: a fiber coupler 121 for separating the low-coherence light emitted from the optical fiber light source 101 into a signal-light Ls and a reference-light Lr, and for combining the signal-light Ls′ reflected from a predetermined depth of the target subject 10 and the the reference-light Lr to obtain an interference signal Lc; a fiber coupler 122 and a fiber coupler 123 provided between the light source portion 100 and the fiber coupler 121; a Piezo element 124 for slightly shifting the frequency of the reference-light Lr; a fiber 125 for connecting the light source portion 100 and the fiber coupler 122; a fiber 126 for connecting the aiming-light source portion 110 and the fiber coupler 123; a fiber 127 for connecting the balance differential detecting portion 150 and the optical path extending portion 130, by way of the fiber couplers 121 and 122; and a fiber 128 for connecting the light-scanning portion 140 and the balance differential detecting portion 150, by way of the fiber coupler 121. Note that the fibers 125, 127, and 128 are single mode optical fibers.

The optical path extension portion 130 comprises: a lens 131 for converting the reference-light Lr emitted from the fiber 127 to a parallel light and for causing the reflected reference-light Lr to enter the fiber 127; a prism 132 for changing the length of the optical path of the reference-light Lr by moving said prism in the horizontal direction indicated in FIG. 1; and a drive unit 133 for moving said prism 132 in the horizontal direction.

The light scanning unit 140 comprises: a lens 141 for guiding the signal-light Ls emitted from the fiber 128 to the target subject 10, and for causing the reflected signal-light Ls′ to enter the fiber 128; a mirror 142; a mirror 143; a lens 144; and a drive portion 145 for driving the mirrors 142 and 143. The drive portion 145 is connected to a manual input portion (not shown), and depending on a manual input to said manual input portion, a desired straight line portion is scanned by the light scanning portion 140. Note that the light scanning portion 140 is a part of an attachment for use in open surgery (not shown).

The balance differential detecting portion 150 comprises a photodetector 151 and a photodetector 152 for measuring the signal strength of the interference signal Lc, and a differential amplifier 153 for adjusting the input balance of the detection values output by the photodetectors 151 and 152 and canceling out the noise component and drift component thereof, and then amplifying the difference therebetween.

Next, the operation of the optical tomographic image diagnostic data output system according to the current embodiment will be described. First, the red aiming-light emitted from the semiconductor laser 111 of the aiming-light source portion is focused by the lens 112 and enters the fiber 126. The aiming-light passes through the fiber 126, the fiber coupler 123, the fiber 125, the fiber coupler 122, the fiber 127, the fiber coupler 121, and the fiber 128, and is projected onto the target subject 10 as a red spot beam by way of the lens 141, the mirror 142, the mirror 143 and the lens 144.

The angle at which the mirror 142 and the mirror 143 are disposed is controlled by the drive portion 145, in response to a manual input inputted to a manual input portion (not shown). An operator sets the starting position and the finishing position of the measurement operation at the drive portion 145, by use of the aiming-light.

After the position of the measurement area has been set, the low-coherence light for obtaining an optical tomographic image is emitted from the light source portion 100. When the operation to take a measurement is initiated, the mirrors 142 and 143 are controlled by the drive portion 145 so as to be disposed at the angle at which the measurement initiation position is irradiated by the light emitted from the fiber 128. First, the excitation light having a wavelength of 600 nm emitted from the semiconductor laser 102 is focused by the lens 103 and enters the core 107 of the optical fiber light source 101.

As the excitation light is conveyed within the core 107, said excitation light is absorbed by the colorants with which the core 107 has been doped. Because the optical fiber light source 101 is not structured as an optical resonator, each individual light emitted is randomly amplified, with no interrelatedness therebetween; the light is conveyed through the core 107, and emitted from the output face of the optical fiber light source 101 as spontaneously emitted light. This spontaneously emitted light is a low-coherence light having the spectral characteristics determined by the spectra produced by the colorants with which the core 107 has been doped, and the conveyance characteristics of the optical fiber light source 101. The optical fiber light source 101 employed in the current embodiment emits low coherence light having a core wavelength of substantially 800 nm and a coherence length of 1.4 um; said low coherence light is converted to a parallel light by the lens 105, and after being transmitted by the excitation light cutoff filter 104, is focused by the lens 106 and enters the fiber 125.

The low coherence light which passed through the fiber 125 enters the fiber 127 at the fiber coupler 122, and is separated at the fiber coupler 121 into a reference-light Lr that proceeds within fiber 127 in the direction toward the optical path extending portion 130, and a signal-light Ls that proceeds within the fiber 128 in the direction toward the light scanning portion 140. The reference-light Lr is modulated by the Piezo element 124 provided on the optical path, causing a slight difference Δf between the frequency of the reference-light Lr and the frequency of the signal-light Ls to occur.

The signal-light Ls is projected onto the target subject 10 by way of the lens 141, mirror 142, mirror 143, and lens 144 of the light scanning unit 140. The signal-light Ls′, which is the component of the signal-light Ls entering the target subject 10 that has been reflected at a predetermined depth thereof, is fed back via the lens 141, the mirror 142, the mirror 143, and the lens 144 to the fiber 128. The signal-light Ls′ that is fed back to the fiber 128 is combined in the fiber 121 with the reference-light Lr fed back to the fiber 127, which is described below.

On the other hand, the reference-light Lr that has been modulated by the Piezo element 124 passes through the fiber 127 and enters the prism 132 through the lens 131 of the optical path extending portion 130, said modulated reference-light Lr is then reflected by the prism 132 and is again transmitted by the lens 131 and fed back to the fiber 127. The reference-light Lr fed back to the fiber 127 is combined in the fiber 121 with the signal-light Ls′ described above.

The signal-light Ls′ and the reference-light Lr combined in the fiber 121 are again combined along the same axis, and at a predetermined timing, interference is caused between said signal-light Ls′ and reference-light Lr, whereby said signal-light Ls′ and reference-light Lr become an interference signal Lc and a light-beat signal is produced.

Because the signal-light Ls and the reference-light Lr are low-coherence light of a short interference-susceptibility distance, after the low-coherence light has been separated into the signal-light Ls and the reference-light Lr, if the length of the optical path of the signal-light Ls (Ls′) up to the point at which said signal-light Ls(Ls′) arrives at the fiber 121 is substantially the same as the length of the optical path of the reference-light Lr up to the point at which said reference-light Lr arrives at the fiber 121, both of said lights interfere with each other, said interference repeats in a strong-weak cycle according to the difference Δf between the frequencies of the reference-light Lr and the signal-light Ls, and a light-beat signal is generated thereby.

The interference signal Lc is separated in the fiber 121: one of the separated components thereof enters the photodetector 151 of the balance differential detector 150 after passing through the fiber 127; and the other of the separated components thereof enters the photodetector 152 after passing through the fiber 128.

The photodetectors 151 and 152 detect the signal strength of the light beat signal from the interference signal Lc, and the differential amplifier 153 obtains the difference between the detection value of the photodetector 151 and the detection value of the photodetector 152 and outputs said difference to the signal processing portion 160. Note that because the differential amplifier 153 is provided with a function for adjusting the balance of the direct current component of the value input thereto, even in a case, for example, in which drift occurs in the low-coherence light emitted from the light source portion 100, by amplifying the difference after adjusting the balance of the direct current component, the drift component is cancelled out, and only the light-beat signal is detected.

Note that here, the prism 132 is aligned, by the drive portion 133, with the direction of the light axis (the horizontal direction appearing in FIG. 1). Therefore, because the length of the optical path of the reference-light Lr up to the point at which said reference-light Lr arrives at the fiber 121 changes, and the length of the optical path of the signal-light LS (Ls′) changes, the depth at which the tomographic data of the target subject 10 is obtained changes.

According to the operation described above, after the tomographic data of a desired depth from a predetermined point on the surface of a target subject 10 has been obtained, the entry point of the signal-light Ls is moved by the slight movement of mirror142 and the mirror 143 of the light scanning portion 140 in the direction of the finishing position of the measurement operation, which has been set in advance at the drive portion 145, and the tomographic data is obtained to a predetermined depth in the same way. By repeating the above-described operation, the optical tomographic data of the target subject 10 can be obtained from the starting position of the measurement operation to the finishing position thereof.

The signal processing portion 160 performs a heterodyne detection to detect the strength of the signal-light LS′ reflected by a predetermined surface of the target subject 10 from the signal strength of the signal-light Ls, converts the obtained strength of the signal-light Ls′ to optical tomographic data, and outputs said optical tomographic data to the monitor 13 and the diagnostic data output portion 180 of the data output portion 12.

Note that because the low-coherence light emitted from the light source portion 100 has a coherence length of 1.4 um, the resolution occurring in the low-coherence light interference is also 1.4 um, and it is therefore possible to obtain microscopic level ultra high resolution optical tomographic images of the cellular level of a target subject, etc.

The diagnostic data output portion 180 performs pattern-matching between the form-pattern of an optical tomographic image data obtained of a tissue known to be in the normal state, which has been prerecorded in the memory portion 170 as a standard optical tomographic image data and the form-pattern of the optical tomographic image data output from the image processing portion 160; for cases in which the two form-patterns substantially match, the target subject is recognized to be a tissue in the normal state, and for cases in which the two form-patterns do not substantially match, the target subject is recognized to be a tissue suspected of being in a diseased state, and data indicative thereof is output to the monitor 13. The monitor 13 displays as a visible image the optical tomographic image data output from the signal processing portion 160, and displays as text the data output from the data output portion 12.

According to the operation described above, the form-pattern of optical tomographic image data obtained of a target subject 10 is compared to the form-pattern of optical tomographic image data obtained of a tissue known to be in the normal state, and because the data (the diagnostic data relating to the tissue state of the target subject) indicating whether or not the form-pattern of the optical tomographic image data obtained of a target subject 10 and the form-pattern of an optical tomographic image data obtained of a tissue known to be in the normal state substantially match is output, an operator can perform the diagnosis of the tissue state of the target subject, based on said output data. Therefore, even for cases in which diagnosing the tissue state of the target subject would be impossible or difficult for a pathologist to perform, the operator can expediently perform the diagnosis during a-surgical procedure. Further, because the diagnosis of the tissue state of a target subject is performed based on the pattern-matching process, there is no inconsistency between the diagnostic results obtained by each individual operator, and the reliability of the diagnostic data is thereby improved.

Further, because it is not necessary that the target subject 10 be a portion of tissue surgically removed from the body of a patient, and the pathological diagnosis of the tissue state of a target subject can be performed in a non-invasive manner on a portion of the body of the patient, the burden on the patient can thereby be reduced.

Still further, because the wavelength band of the low-coherence light is 800 nm, and that light has desirable transmittance and dispersion characteristics, a desired optical tomographic image data can be obtained.

Note that according to the current embodiment, although an optical tomographic image data obtained of a tissue known to be in the normal state has been employed as a standard optical tomographic image data, the current embodiment is not limited to this, an optical tomographic image data obtained of a tissue known to be in a diseased state can also be employed as a standard optical tomographic image data. In this case a determination is made as to whether or not the form-pattern of the optical tomographic image data obtained of the target subject 10 substantially matches the form-pattern of the optical tomographic image data obtained of a tissue known to be in a diseased state, and if said two form-patterns substantially match, the name of the pathology of the tissue of which the standard optical tomographic image data has been obtained can be output.

Further, according to the current embodiment, although the result of the determination as to whether or not the form-pattern of the optical tomographic image obtained of the target subject 10 and the form-pattern of a standard optical tomographic image substantially match has been output as the data based on the comparison of said two form-patterns, the current embodiment is not limited to this; for example, the degree of matching between the two form-patterns compared can be output as a numerical value. In this case, because data indicative of the degree to which the form-pattern of the optical tomographic image data obtained of a target subject 10 differs from the form-pattern of the standard optical tomographic image data, the range of penetration of a pathology can be determined more efficiently.

The second embodiment of the present invention, has all of the elements of the first embodiment except the data output portion 12. In its stead, there is provided a data output portion 20 which comprises a memory portion 200 for prerecording as standard optical tomographic image data a plurality of optical tomographic image data, including an optical tomographic image obtained of a tissue known to be in the normal state and at least one optical tomographic image data obtained of a tissue known to be in a type of diseased state; and a diagnostic data output portion 210 for determining which form-pattern from among the form-patterns of said plurality of standard optical tomographic image data most closely matches the form-pattern of the optical tomographic image data obtained of the target subject 10, and outputting data indicative of the result thereof to a monitor. By utilizing the data output portion 20, in addition to obtaining the same result as can be obtained in the first embodiment, diagnostic data indicative of which tissue state from among a plurality of types of known tissue states the tissue state of the target subject most closely matches can be obtained on the spot. Therefore, data relating to the type of tissue state a target subject is in can be output during the performance of surgery, and the advantages gained by using the optical tomographic diagnostic data output apparatus of the above described configuration can be increased thereby.

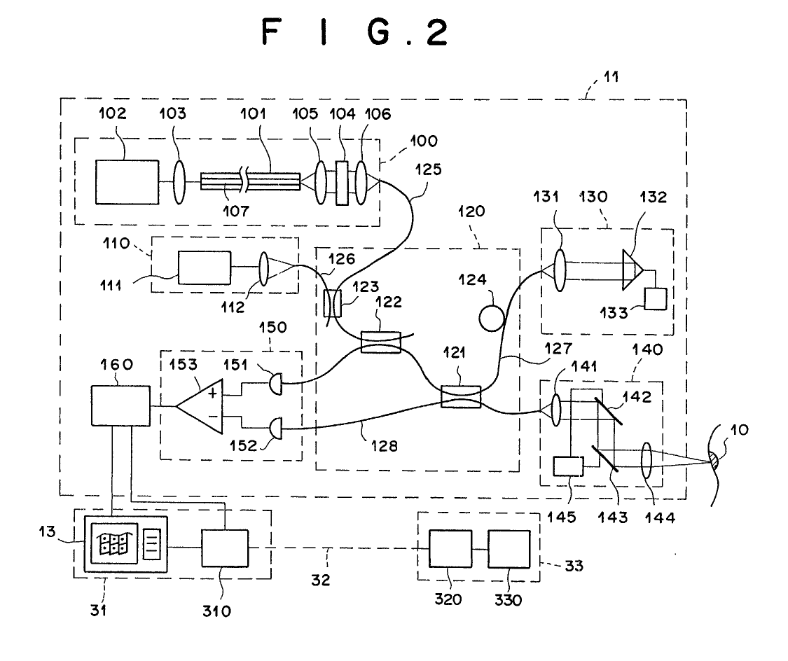

Next, the third embodiment of an optical tomographic image data output apparatus according to the present invention will be described, with reference to FIG. 2. FIG. 2 is a schematic drawing of an optical tomographic image diagnostic data output apparatus implementing the optical tomographic image diagnostic data output method according to the third embodiment of the present invention. According to the optical tomographic image diagnostic data output apparatus according to the current embodiment, an optical tomographic image obtained of a target subject 10 is transmitted by a transmitting and receiving portion 310 over a public communications network 32 to a data output portion 33 provided at a remote location; the diagnostic data relating to the tissue state of the transmitted optical tomographic image is obtained by said data output portion 33 at said remote location and transmitted over a public communications network to said transmitting and receiving portion 310, which receives and displays said diagnostic data on a monitor 13.

The optical tomographic image data output apparatus according to the current embodiment comprises: an OCT portion 11 for obtaining an optical tomographic image data of a target subject 10; a display portion 31 for transmitting the optical tomographic image data obtained by said OCT portion 11, receiving the diagnostic data relating to the tissue state of the target subject of said transmitted optical tomographic image data, and displaying said optical tomographic image data and the diagnostic data relating to the tissue state of said target subject; a public communications network 32 for conveying an optical tomographic image data and the diagnostic data relating to the tissue state of the target subject thereof; and a data output portion 33 for obtaining and transmitting the diagnostic data based on the transmitted optical tomographic image data. Note that elements that are the same as those occurring in the first embodiment shown in FIG. 1 are likewise labeled, and in so far as it is not particularly required, further explanation thereof has been omitted.

The display portion 31 comprises a transmitting and receiving portion 310 for transmitting the optical tomographic image data obtained by the OCT portion 11 over the public communications network 32 to the data output portion 33, and also for receiving the diagnostic data obtained based upon the transmitted optical tomographic image data and relating to the tissue state of the target subject 10 thereof, and outputting said diagnostic data to the monitor 13; and a monitor 13 for displaying the optical tomographic image obtained of the target subject 10 by the OCT portion 11 and the diagnostic data relating to thereof.

The data output portion 33 comprises: a memory portion 330 for prerecording as standard optical tomographic image data a plurality of optical tomographic image data, including optical tomographic image data obtained of a tissue known to be in the normal state and at least one optical tomographic image data obtained of a tissue known to be in a type of diseased state; and a diagnostic data output portion 320 for performing pattern-matching between the form-pattern of the optical tomographic image data obtained of the target subject 10 and the form-pattern of each of said standard optical tomographic image data, each of which has been obtained of a tissue known to be in a certain state, to determine which form-pattern from among the form-patterns of said plurality of standard optical tomographic image data most closely matches the form-pattern of the optical tomographic image data obtained of the target subject 10, and transmitting data indicative of the result thereof, that is, the diagnostic data relating to the tissue state of said target subject 10, over the public communications network 32 to the display portion 31. Note that the transmitting and receiving portion 310 forms the transmitting and the receiving means according to the present invention.

Next, the operation of the optical tomographic image diagnostic data output apparatus according to the current embodiment will be described. First, the OCT portion 11 obtains optical tomographic image data of a target subject 10 by the same operation as occurred in the first embodiment, and then outputs said optical tomographic image data to the transmitting and receiving portion 310 and the monitor 13.

The transmitting and receiving portion 310 first transmits the obtained optical tomographic image data over the public communications network 32 to the diagnostic data output portion 320 of the data output portion 33 provided at a remote location.

The diagnostic data output portion 320 performs pattern-matching between the optical tomographic image data obtained of the target subject 10, which has been transmitted over the public communications network 32, and said standard optical tomographic image data, each of which has been obtained of a tissue known to be in a certain state and prerecorded in the memory portion 330, to determine which form-pattern from among the form-patterns of said plurality of standard optical tomographic image data most closely matches the form-pattern of the optical tomographic image data obtained of the target subject 10, and transmits data indicative of the result thereof over the public communications network 32 to the transmitting and receiving portion 310 of the display portion 31.

The display portion 31 displays the optical tomographic image data output from the data processing portion 160 on the monitor 13 as a visible image, and displays as text the result of the pattern-matching determination received from the transmitting and receiving portion 310 on the monitor 13.

According to the operation described above: an optical tomographic image data obtained of a target subject 10 by the use of the low-coherence interference of a low-coherence light having a coherence length of 1.4 um is transmitted over a public communications network 32 to a remote location; and by receiving, again, over the public communications network 32, the diagnostic data obtained at said remote location based on said transmitted optical tomographic image data, at the location at which said optical tomographic image was obtained, even for cases in which there is no pathologist present or cases in which it is not possible to obtain said diagnostic data, because the diagnostic data obtained at said remote location and output therefrom can be received at said location at which said optical tomographic image was obtained, an operator can perform said diagnosis based on said received diagnostic data. Therefore, it becomes possible to perform expedient diagnosis even while surgery is being performed. Further, because the public communications network 32 is used as the communications network, even if the data output portion 33 is provided at a remote location, expedient diagnosis is possible, and there is little increase in the cost required for the transmission.

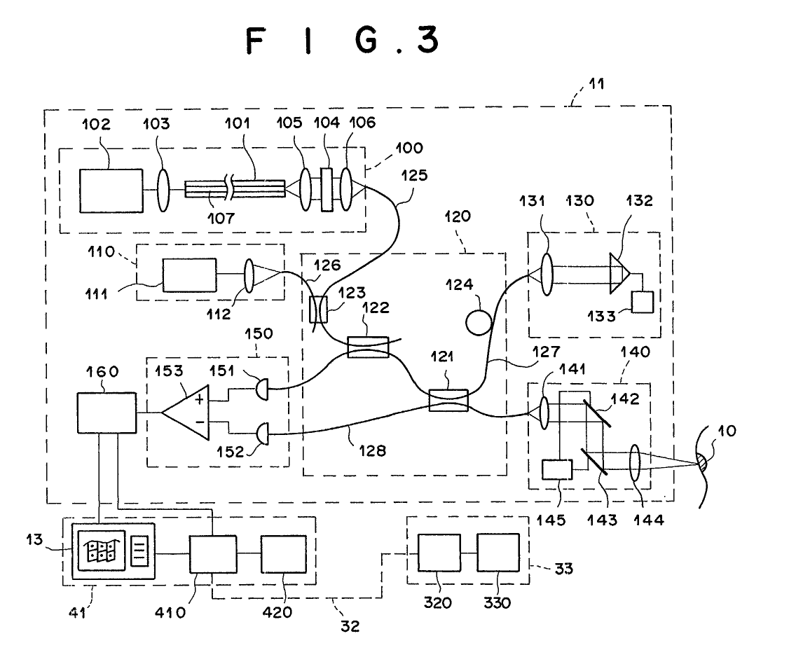

Next, the fourth embodiment of an optical tomographic image data output apparatus according to the present invention will be described, with reference to FIG. 3. FIG. 3 is a schematic drawing of an optical tomographic image diagnostic data output apparatus implementing the optical tomographic image diagnostic data output method according to the fourth embodiment of the present invention. According to the optical tomographic image diagnostic data output apparatus according to the current embodiment, first, pattern-matching is performed between an optical tomographic image data obtained of a target subject 10 and an optical tomographic image data obtained of a tissue known to be in the normal state, and a simple diagnosis is performed to determine whether or not the target subject 10 can be identified with surety as being in the normal state. If the form-patterns of the two images substantially match, a message indicating that the result of the pattern-matching process that the target subject is almost certainly in the normal state is displayed on the monitor 13; only for cases in which the form-patterns of the two images do not substantially match, the optical tomographic image data obtained of the target subject 10 is transmitted over the public communications network 32 to data output portion 33, and the diagnostic data obtained by said data output portion 33, based on said transmitted optical tomographic image data, is received therefrom via the public communications network 32 and displayed on the monitor 13.

The optical tomographic image data output apparatus according to the current embodiment comprises: an OCT portion 11 for obtaining optical tomographic image data of a target subject 10; a display portion 41 for performing a simple diagnosis of the optical tomographic image data obtained by said OCT portion 11, transmitting said optical tomographic image data, receiving the diagnostic data relating to the tissue state of the target subject of said transmitted optical tomographic image data, and displaying said optical tomographic image data and the diagnostic data relating to the tissue state of said target subject; a public communications network 32 for conveying optical tomographic image data and the diagnostic data relating to the tissue state of the target subject thereof; and a data output portion 33 for obtaining and transmitting the diagnostic data based on the transmitted optical tomographic image. Note that elements that are the same as those occurring in the third embodiment shown in FIG. 2 are likewise labeled, and in so far as it is not particularly required, further explanation thereof has been omitted.

The display portion 41 comprises a memory portion 420 for prerecording as standard optical tomographic image data, optical tomographic image data obtained of a tissue known to be in the normal state by use of the OCT means; a determining and transmitting portion 410 for performing a simple diagnosis of the optical tomographic image outputted from the signal processing portion 160, and transmitting said optical tomographic image data over the public communications network 32 to the data output portion 33; and a monitor 13 for displaying said optical tomographic image and the diagnostic data relating to the tissue state of the target subject 10 thereof.

The determining and transmitting portion 410, upon the input thereto from the signal processing portion 160 of an optical tomographic image data obtained of a target subject 10 by the OCT portion 11, performs pattern-matching between the form-pattern of said optical tomographic image data obtained of the target subject 10 and the form-pattern of a standard optical tomographic image data obtained of a tissue known to be in the normal state and which has been prerecorded in the memory portion 420, and determines that the target subject is in the normal state if the two said form-patterns substantially match, and outputs data indicative of the result thereof to the monitor 13. For cases in which the two said form-patterns do not match, said optical tomographic image data is transmitted over the public communications network 32 to the diagnostic data output portion 320 of the data output portion 33. The data output portion 33 performs the determining process in the same way as occurred in the third embodiment, and the diagnostic data output portion 320 transmits the diagnostic data relating to the tissue state of said target subject 10 over the public communications network 32 to the determining and transmitting portion 410. The determining and transmitting portion 410 receives the transmitted diagnostic data relating to the tissue state of the target subject of the transmitted optical tomographic image data, and displays said diagnostic data on the monitor 13.

The monitor 13 displays as a visible image the optical tomographic image data outputted from the signal processing portion 160, and also displays as text the result of the determination process performed by the determining and transmitting means 410 or the diagnostic data relating to the tissue state of the target subject of said optical tomographic image data output from the data output portion 33. Note that the determining and transmitting portion 410 forms the transmission means and the receiving means of the present invention.

According to the operation described above: first, at the location at which an optical tomographic image of a target subject 10 has been obtained, the form-pattern of said optical tomographic image data obtained of the target subject 10 and the form-pattern of a standard optical tomographic image data obtained of a tissue known to be in the normal state are compared; and only for cases in which the two said form-patterns do not match, said optical tomographic image data is transmitted over the public communications network to a remote location, and by receiving via the public communications network the diagnostic data obtained at said remote location based on said transmitted optical tomographic image data; because the diagnostic data relating to the tissue state of the target subject is obtained thereby, in the same way as occurred in the third embodiment of the present invention, even for cases in which there is no pathologist present or cases in which it is not possible to obtain said diagnostic data at the location at which said optical tomographic image was obtained, because the diagnostic data obtained at said remote location and output therefrom can be received at said location at which said optical tomographic image was obtained, an operator can perform said diagnosis based on said received diagnostic data. Therefore, it becomes possible to perform expedient diagnosis even while surgery is being performed. Further, for cases in which the form-pattern of the optical tomographic image obtained of the target subject 10 and the form-pattern of the standard optical tomographic image data obtained of a tissue known to be in the normal state match, that is, for cases in which it is not necessary to obtain more detailed diagnostic data thereof or the necessity to do so is low, because the transmission of image data, etc. is not performed, the volume of data transmitted can be reduced. Further, the time required at the remote location for obtaining the diagnostic data can be reduced.

Note that according to the third ad fourth embodiments, the communications network to be employed is not limited to being a public communications network; if, for example, the remote location to receive a transmission is another location within a large hospital, the communications network can be the hospital's LAN network or the like.

Further, although a transmitting means that is part of a single, integrated transmitting and receiving means has been employed, the transmitting means is not limited to being of such configuration; as long as the transmitting means employed is a means that can transmit image data, any number of options are available; further, as to the receiving means, as long a means that can receive diagnostic data is employed, any number of options, such as email or FAX, are available.

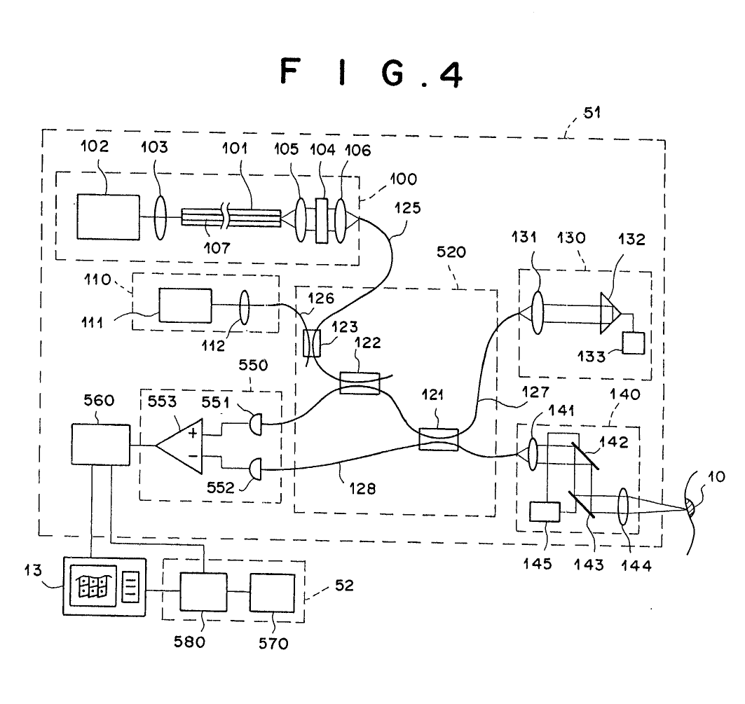

Next, the fifth embodiment of an optical tomographic image data output apparatus according to the present invention will be described, with reference to FIG. 4. FIG. 4 is a schematic drawing of an optical tomographic image diagnostic data output apparatus implementing the optical tomographic image diagnostic data output method according to the fourth embodiment of the present invention. According to the optical tomographic image diagnostic data output apparatus of the current embodiment, instead of the heterodyne detection OCT portion 11 employed in the optical tomographic image diagnostic data output apparatus according to the first embodiment shown in FIG. 1, a light-separation OCT portion 51 is employed, and when the diagnostic data relating to the tissue state of the target subject of an optical tomographic image data is to be obtained, pattern-matching employing form-patterns and light-separation patterns is performed.

The optical tomographic image data output apparatus according to the current embodiment comprises: an OCT portion 51 for obtaining an optical tomographic image data of a target subject 10; a data output portion 52 for performing pattern matching between the optical tomographic image data obtained by said OCT portion 51 and the optical tomographic image data obtained of a tissue known to be in the normal state to determine whether or not both the form-patterns and the light-separation patterns thereof substantially match; and a monitor 13 for displaying as a visible image the optical tomographic image data obtained of the target subject 10, as well as the diagnostic data outputted from the data output portion 52 relating to the tissue state of said target subject. Note that elements that are the same as those occurring in the first embodiment shown in FIG. 1 are likewise labeled, and in so far as it is not particularly required, further explanation thereof has been omitted.

The OCT portion 51 is a light-separation OCT portion and comprises: a low-coherence light source portion 100 for emitting a low-coherence light; an aiming-light source portion 110 for emitting an aiming-light; a fiber optical coupling system 520 for separating the low-coherence light into a signal-light Ls and a reference-light Lr, as well as combining the signal-light Ls and the reference-light Lr; an optical path extending portion 130 disposed on the optical path of the reference-light Lr; a light scanning portion 140 for scanning the target subject 10 with the signal-light Ls; a balance differential detecting portion 550 for detecting the signal strength of the interference signal Lc between the signal-light Ls′ reflected from a predetermined surface of the target subject 10 and the reference-light Lr; and a signal processing portion 560 for performing a detection process to obtain the strength of the signal-light Ls′ reflected from a predetermined surface of the target subject 10 from the strength of the interference signal Lc detected by the balance differential detection portion 550, and also for subjecting the interference signal Lc to a Fourier transform to obtain the light-separation data contained within the signal-light Ls′ reflected from a predetermined surface of the target subject 10, and forming an optical tomographic image data that is a pseudo-color image reflecting the reflectance ratio of the signal-light Ls and the light-separation data.

The data output portion 52 comprises: a memory portion 570 for prerecording as a standard optical tomographic image data an optical tomographic image data obtained by the OCT portion 51 of a tissue which is known to be in the normal state; and a diagnostic data output portion 580 for performing pattern matching between the form-pattern and the light-separation pattern of the optical tomographic image data obtained of the target subject 10 by the OCT portion 51 and the form-pattern and the light-separation pattern of the standard optical tomographic image data prerecorded in the memory portion 570, that determines that the target subject is in the normal state if the form-pattern and the light-separation pattern of the optical separation image obtained of the target subject 10 and the form-pattern and the light-separation pattern of the standard optical separation image substantially match, and determines that the target subject is suspected to be in a diseased state if the form-pattern and the light separation pattern of the optical tomographic image data obtained of the target subject 10 and the form-pattern and the light separation pattern of the standard optical tomographic image data do not substantially match. Note that the color characteristics occurring in a pseudo-color display are used as the light separation pattern.

The fiber optics coupling system 520 of the OCT portion 51 comprises: a fiber coupler 121 for separating the low-coherence light emitted from the optical fiber light source 101 into a signal-light Ls and a reference-light Lr, and for combining the signal-light Ls′ reflected from a predetermined depth of the target subject 10 and the reference-light Lr to obtain an interference signal Lc; a fiber coupler 122 and a fiber coupler 123 provided between the light source portion 100 and the fiber coupler 121; a fiber 125 for connecting the light source portion 100 and the fiber coupler 122; a fiber 126 for connecting the aiming-light source portion 110 and the fiber coupler 123; a fiber 127 for connecting the balance differential detecting portion 550 and the optical path extending portion 130, by way of the fiber couplers 121 and 122; and a fiber 128 for connecting the light-scanning portion 140 and the balance differential detecting portion 550, by way of the fiber coupler 121. Note that the fibers 125, 127, and 128 are single mode optical fibers. That is to say, the fiber optical coupling system 520 employed in the current embodiment is the fiber optical coupling system 120 occurring in the first embodiment without the Piezo element 124.

The balance differential detecting portion 550 comprises a photodetector 551 and a photodetector 552 for measuring the signal strength of the interference signal Lc, and a differential amplifier 553 for adjusting the input balance of the detection values output by the photodetectors 551 and 552 and canceling out the noise component and drift components thereof, and then amplifying the difference between therebetween.

Next, the operation of the optical tomographic image diagnostic data output apparatus according to the current embodiment will be described. In the same way as occurred in the first embodiment, the starting position and the finishing position of the measurement operation are set in the drive portion 145 by the use of the aiming-light.

After the measurement position has been set, the low-coherence light for obtaining an optical tomographic image is emitted from the light source portion 100. When the operation to take a measurement is initiated, the mirrors 142 and 143 are controlled by the drive portion 145 so as to be disposed at the angle at which the measurement initiation position is irradiated by the light emitted from the fiber 128.

The low-coherence light emitted from the optical fiber light source 101 is guided into the fiber 125 and enters the fiber 127 at the fiber coupler 122, and is separated at the fiber coupler 121 into a reference-light Lr, which proceeds within the fiber 127 in the direction toward the optical path extending portion 130, and a signal-light Ls which proceeds within the fiber 128 in the direction toward the light scanning portion 140.

The signal-light Ls′, which is the component of the signal-light Ls entering the target subject 10 that has been reflected at a predetermined depth thereof, is fed back via the lens 141, the mirror 142, the mirror 143, and the lens 144 to the fiber 128. The signal-light Ls′ fed back to the fiber 128 is combined in the fiber coupler 121 with the reference-light Lr reflected by the prism 132 of the optical path extending portion 130.

The signal-light Ls′ and the reference-light Lr combined in the fiber 121 are again combined along the same axis, and under predetermined conditions, interference is caused in said signal-light Ls′ and reference-light Lr, whereby said signal-light Ls′ and reference-light Lr become an interference signal Lc.

The interference signal Lc is separated in the fiber coupler 121: one of the separated components thereof enters the photodetector 551 of the balance differential detector 550 after passing through the fiber 127; and the other of the separated components thereof enters the photodetector 552 after passing through the fiber 128. The photodetectors 551 and 552 detect the signal strength of the light beat signal from the interference signal Lc, and the differential amplifier 153 obtains the difference between the detection value of the photodetector 551 and the detection value of the photodetector 552 and outputs said difference to the signal processing portion 560.

The signal processing portion 560 obtains the strength of the signal-light Ls′ reflected from a predetermined depth of the target subject 10 from the signal strength of the interference signal Lc detected by the balance differential detecting portion 550, subjects the interference signal Lc to a Fourier transform to obtain the light-separation data contained within the signal-light Ls′ reflected from a predetermined depth of the target subject 10, forms an optical tomographic image data that is a pseudo-color image reflecting the reflectance ratio of the signal-light Ls and the light-separation data, and outputs said optical tomographic image data to the monitor 13 and the diagnostic data output portion 580 of the data output portion 52.

The diagnostic data output portion 580 performs pattern-matching between the form-pattern and the light-separation pattern of an optical section image data obtained by the OCT portion 51 of a tissue known to be in the normal state, which has been prerecorded in the memory portion 570 as a standard optical tomographic image data and the form-pattern and the light-separation pattern of the optical tomographic image data output from the image processing portion 560; for cases in which the form-patterns and the light-separation patterns of the two said optical separation image data substantially match, the target subject is recognized to be a tissue in the normal state, and for cases in which the form-patterns and the light-separation patterns of the two said optical separation image data do not substantially match, the target subject is recognized to be a tissue suspected of being in a diseased state, and data indicative thereof is output to the monitor 13. The monitor 13 displays as a visible image the optical tomographic image data output from the signal processing portion 560, and displays as text the data output from the data output portion 52.

According to the operation described above, after the optical sectional data of a desired depth from a predetermined point on the surface of a target subject 10 has been obtained, the entry point of the signal-light Ls is moved by the mirror142 and the mirror 143 of the light scanning portion 140 are moved slightly in the direction toward the finishing position of the measurement operation, which has been set in advance at the drive portion 145, and the optical sectional data is obtained to a predetermined depth in the same way. By repeating the above-described operation, the optical sectional data of the target subject 10 can be obtained from the starting position of the measurement operation to the finishing position thereof.

According to the operation described above, the form-pattern and the light separation pattern of an optical tomographic image data obtained of a target subject 10 are compared to the form-pattern and the light-separation pattern of an optical tomographic image data obtained of a tissue known to be in the normal state, and because the result obtained by the process for determining whether or not the form-pattern and the light-separation pattern of the optical tomographic image data obtained of a target subject 10 and the form-pattern and the light-separation pattern of an optical tomographic image data obtained of a tissue known to be in the normal state substantially match is output as the diagnostic data relating to the tissue state of the target subject, an operator can perform the diagnosis of the tissue state of the target subject, based on said output data. Moreover, because the pattern-matching is carried out between two types of patterns, the form-pattern and the light-separation pattern, the reliability of the result obtained by said determination process, which is then output, is thereby improved.

Note that according to the current embodiment, although the diagnostic data relating to the tissue state of the target subject has been obtained based on the performance of pattern-matching between two types of patterns, a form-pattern and a light separation pattern, the diagnostic data can be obtained by performing pattern-matching between only the form-patterns, or only the light-separation patterns.

Further, as the result of the process for determining whether or not the form-patterns and the light-separation patterns substantially match, the degree of matching between each pattern, for example, can be output as numerical data. Note that according to the second, third and fourth embodiments of the present invention, a light-separation OCT portion can be employed.

Still further, as an alternative version for each of the embodiments described above, an OCT portion combining both a heterodyne detection OCT portion and a light-separation OCT portion can be employed, and the operation of the Piezo element, which serves as a frequency shifter, the photodetector, the signal processor, and the data output portion can be switched by use of a switch, whereby either of said OCT portions can be used. In this way, by using a single optical tomographic image diagnostic data output apparatus, the diagnostic data based on an optical tomographic image data obtained by the heterodyne detection OCT portion and the diagnostic data based on an optical tomographic image data obtained by the light-separation OCT portion can be obtained. When the heterodyne detection OCT portion is employed, although no light-separation data is obtained, because reflectance data having a favorable S/N ratio is obtained, for cases in which an optical tomographic image data having a S/N ratio better than that contained in a light-separation data, the heterodyne detection OCT can be used; for cases in which diagnostic data based on an optical tomographic image data obtained by a light-separation OCT portion is required, the light-separation OCT portion can be used, whereby the flexibility and versatility of the optical tomographic image diagnostic data output apparatus can be improved. Note that when switching between OCT portions, the photodetection method, the signal processing method, the pattern-matching method, and so on must be also be changed accordingly.

Note that according to each of the embodiments described above, although the memory portion and the diagnostic data output portion are provided at the same location, the present invention is not limited to being of such configuration: for example, the memory portion can be provided at a location different from that at which the diagnostic data output portion has been provided, in which case, the standard optical tomographic image data can be transmitted to the diagnostic data output portion over a communications network.

What is claimed is:

1. A method of outputting optical tomographic image diagnostic data, comprising the steps of
obtaining an optical tomographic image of the target subject by using the interference of a low-coherence light having a coherence length of 5 um or less,
comparing the pattern occurring in the optical tomographic image obtained of the target subject to the pattern of an optical tomographic image obtained of a tissue known to be in the normal state and/or the pattern of an optical tomographic image obtained of a tissue known to be in a diseased state, and
outputting the diagnostic data based upon said comparison.

2. A method of outputting optical tomographic image diagnostic data, comprising the steps of
obtaining an optical tomographic image of the target subject by using the interference of a low-coherence light having a coherence length of 5 um or less,
comparing the pattern occurring in the optical tomographic image obtained of the target subject to a plurality of patterns of optical tomographic images, each of which has been obtained of a tissue known to be in a certain state, including the pattern of an optical tomographic image obtained of a tissue known to be in the normal state and the pattern of at least one optical tomographic image obtained of a tissue known to be in a type of diseased state,
determining which pattern, from among the plurality of patterns of the optical tomographic images, each of which has been obtained of a tissue known to be in a certain state, most closely matches that of the optical tomographic image obtained of the target subject, and
outputting the diagnostic data based upon said comparison.

3. A method of obtaining and outputting diagnostic data relating to the tissue state of a target subject as defined in either of claim 1 or 2, further comprising the steps of
transmitting the optical tomographic image obtained of the target subject over a communications network to a remote location,
obtaining, at said remote location, the diagnostic data relating to the tissue state of the target subject of said optical tomographic image transmitted thereto, and outputting said diagnostic data, and
receiving, at the location at which the optical tomographic image of the target subject was obtained, the diagnostic data relating to the tissue state of said target subject that has been transmitted from said remote location over the communications network.

4. A method of obtaining and outputting diagnostic data relating to the tissue state of a target subject as defined in either of claim 1 or 2, further comprising the steps of
prerecording an optical tomographic image that has been obtained of a tissue known to be in the normal state,
comparing the pattern of the optical tomographic image obtained of the target subject to the pattern of the optical tomographic image obtained of a tissue known to be in the normal state which is stored in a memory, and determining whether or not the patterns of the two images substantially match,
transmitting, only for cases in which it has been determined that the patterns of the two images do not substantially match, the optical tomographic image obtained of the target subject over a communications network to a remote location,
performing at said remote location the operation to obtain the diagnostic data based on the optical tomographic image obtained of the target subject and outputting the diagnostic data obtained thereby, and
receiving via the communications network, at the location at which the optical tomographic image of the target subject was obtained, the diagnostic data relating to the tissue state of said target subject, which has been obtained at said remote location.

5. An apparatus for outputting optical tomographic image diagnostic data, comprising
an OCT means for obtaining an optical tomographic image by using the interference caused by a low-coherence light having a coherence length of 5 um or less,
recording means for prerecording an optical tomographic image obtained of a tissue known to be in the normal state and/or an optical tomographic image of an image known to be in a diseased state, and
a diagnostic data output means for outputting, based on a comparison of the pattern of the optical tomographic image obtained of the target subject by the OCT means to the pattern of an optical tomographic image obtained of a tissue known to be in the normal state and/or the pattern of an optical sectional tissue obtained of a tissue known to be in a diseased state, the diagnostic data relating to the tissue state of said target subject.

6. An apparatus for outputting optical tomographic image diagnostic data, comprising
an OCT means for obtaining an optical tomographic image by using the interference caused by a low-coherence light having a coherence length of 5 um or less,
recording means for prerecording a plurality of optical tomographic images, each of which has been obtained of a tissue known to be in a certain state, including an optical tomographic image obtained of a tissue known to be in the normal state and at least one optical tomographic image obtained of a tissue known to be in a type of diseased state, and
a diagnostic data output means for obtaining and outputting, based on a comparison of the pattern of the optical tomographic image obtained of a target subject by the OCT means to the pattern of each of said plurality of optical tomographic images obtained of a tissue known to be in a certain state and which include the pattern of an optical tomographic image obtained of a tissue known to be in a normal state and the pattern of at least one optical tomographic image of a tissue known to be in a diseased state in order to determine to which pattern from among said patterns of the optical tomographic images obtained of a tissue known to be in a certain state most closely matches the pattern of said optical tomographic image of the target subject, the diagnostic data relating to the tissue state said target subject.

7. An apparatus for outputting optical tomographic image diagnostic data as defined in either of claim 5 or 6, wherein
the OCT means and the diagnostic data output means are each provided at a locations remote to the other, further comprising
a transmitting means for transmitting an optical tomographic image obtained of a target subject by said OCT means to said diagnostic data output means via a communications network, wherein
said OCT means is provided with a receiving means for receiving via the communications network the data relating to the diagnosis of the tissue state that has been obtained by said diagnostic data output means, based on the transmitted optical tomographic image, and then output.

8. An apparatus for outputting optical tomographic image diagnostic data as defined in either of claim 5 or 6, wherein
the OCT means and the diagnostic data output means are each provided at a locations remote to the other, further comprising
a normal-state pattern recording means for prerecording an optical tomographic images obtained of a tissue known to be in the normal state,
a determining and transmitting portion for comparing the pattern of the optical tomographic image obtained of the target subject to the pattern of the optical tomographic image obtained of a tissue known to be in the normal state to determine whether or not the two patterns substantially match, and transmitting, only for cases in which the two patterns do not substantially match, said optical tomographic image obtained by the OCT means of the target subject to the diagnostic data output means, wherein
said OCT means is provided with a receiving means for receiving via the communications network the data relating to the diagnosis of the tissue state that has been obtained by said diagnostic data output means, based on the transmitted optical tomographic image, and then output.

9. An apparatus for outputting optical tomographic image diagnostic data as defined in either of claim 5 or 6, wherein
the OCT means separates the low-coherence light having a coherence length of 5 um or less into a signal-light and a reference-light, irradiates the target subject with the signal-light, causes interference between the reference-light and the reflected-light of the signal-light reflected from a predetermined depth of the target subject, measures the strength of the interference signal after said interference, and obtains the optical tomographic image of said target subject.

10. An apparatus for outputting optical tomographic image diagnostic data as defined in either of claim 5 or 6, wherein
the OCT means separates the low-coherence light having a coherence length of 5 um or less into a signal-light and a reference-light, shifts the frequency of at least one of the reference-light or the signal-light so as to create a difference between the frequency of the reference-light and the frequency of the signal-light, then irradiates the target subject with the signal-light, causes interference between the reference-light and the reflected-light of the signal-light reflected from a predetermined depth of the target subject, measures the strength of the light-beat signal after said interference, and obtains the optical tomographic image of said target subject.

11. An apparatus for outputting optical tomographic image diagnostic data as defined in either of claim 5 or 6, wherein
said pattern is the pattern of the form and/or the pattern of the light separation.

12. An apparatus for outputting optical tomographic image diagnostic data as defined in either of claim 5 or 6, wherein
the target subject is a portion of a living body.

13. An apparatus for outputting optical tomographic image diagnostic data as defined in either of claim 5 or 6, wherein
the wavelength of the low-coherence light is in the 600-1700 nm range.
